(19) United States
(12) Patent Application Publication
(10) Pub. No.: US 2008/0186990 A1
(43) Pub. Date: Aug. 7, 2008

(54) TRANSLATION MODULE, METHOD AND COMPUTER PROGRAM PRODUCT FOR PROVIDING MULTIPLE INFINIBAND ADDRESS SUPPORT FOR VM MIGRATION USING INFINIBAND ADDRESS TRANSLATION

(75) Inventors: Bulent Abali, Tenafly, NJ (US); Jiuxing Liu, White Plains, NY (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/670,533

(22) Filed: Feb. 2, 2007

(51) Int. Cl. H04L 12/56

(52) U.S. Cl. 370/419

(57) ABSTRACT

To provide for VM migration in an InfiniBand network, a translation module intercepts and InfiniBand packet and performs appropriate translation of the packet's virtual HCA address to a physical HCA address. The translation is based on the mapping table that is updated when a VM is created, destroyed, or migrated from one physical node to another in the InfiniBand network.

### BACKGROUND

This application relates to InfiniBand network address translation, and more particularly, to translation of virtual address into physical addresses to support migration of resources.

Virtual Machine (VM) technologies were first introduced in the 1960s. Recently, they have been experiencing resurgence in both industry and academia. VM technologies provide many benefits, including server consolidation and shared hosting. Many VM environments, including Xen and VMware, also provide the ability to migrate other VMs from one physical node to another. VM migration can greatly improve system reliability, availability, and serviceability.

InfiniBand architecture is a high speed interconnected network based on an industry standard. It offers very good performance with bandwidths in the order of 10 Gbps and latencies that are less than 10 microseconds for small messages. In the past few years, InfiniBand has become a strong player in the area of high performance computers (HPC), where I/O and communicating performance is essential. More recently, it has also been introduced to high-end enterprise systems as an interconnect for networking, clustering, and storage. More details of InfiniBand architecture may be fund at http://www.infinibandta.org/specs/.

Existing work has provided support for allowing InfiniBand Host Channel Adapters (HCAs) to be accessed directly in a VM. Currently, a virtual HCA device is allocated to each VM which can be accessed in a transparent way by using the same software interface as physical HCAs. However, providing migration support for such VMs is a challenging issue. One major obstacle is the fact the current InfiniBand HCAs do not provide flexible support for multiple addresses. Therefore, virtual HCAs used by VMs have to share the same addresses as the physical HCAs. This is because InfiniBand has limited multiple address support thought the Local-identifier Mask Control (LMC) mechanism. LMC can only bind multiple addresses with the same physical HCA but does not allow them to migrate to other nodes. As a result, when a VM migrates from one physical node to another, its virtual HCA address has to change. This is undesirable because it breaks transparency to clients communicating with the VM using InfiniBand.

Accordingly, there is a need for an improved technique for enabling VM migration in an InfiniBand network.

### SUMMARY

According to exemplary embodiments, a translation module, method, and computer program product are provided for enabling VM migration in an InfiniBand network. In one embodiment, an InfiniBand packet, destined for a virtual InfiniBand Host Channel Adapter (HCA) address, is intercepted. An address mapping table mapping virtual HCA addresses to physical HCA addresses is consulted using the destination address of the packet as a virtual HCA address. The mappings of the virtual HCA addresses to the physical HCA addresses are updated when a VM with InfiniBand access is created, destroyed, or migrated from one physical node to another in an InfiniBand network. If there is a physical HCA address in the table that maps to the virtual HCA address of the intercepted packet, the virtual address of the intercepted packet is replaced with the corresponding physical HCA address. If there is no physical HCA address in the mapping table corresponding to the virtual HCA address of the intercepted packet, the packet is forwarded without modification to its destination address.

Additional features and advantages are realized through the techniques of the present invention. Other embodiments and aspects described in detail herein and are considered a part of the claimed subject matter. For a better understanding of the claimed subject matter with advantages and features, refer to the description and to the drawings.

### BRIEF DESCRIPTION OF DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary address translation module according to an exemplary embodiment.

FIG. 2 illustrates an exemplary method for performing address translation according to an exemplary embodiment.

The detailed description explains exemplary embodiments of the invention, together with advantages and features, by way of example with reference to the drawings.

### DETAILED DESCRIPTION OF EMBODIMENTS

According to exemplary embodiments, a technique is provided to support multiple virtual HCA addresses for VM migration in a transparent way, even for existing HCAs that only provide single physical addresses. One embodiment uses a special InfiniBand address translation module, which intercepts InfiniBand packets and modifies them by replacing virtual HCA addresses with physical HCA addresses. The translation module may be implemented as, for example, a standalone device part of an InfiniBand switch or router, or part of an InfiniBand HCA. The performance impact of the technique proposed herein is discussed below, as are several techniques for improving performance.

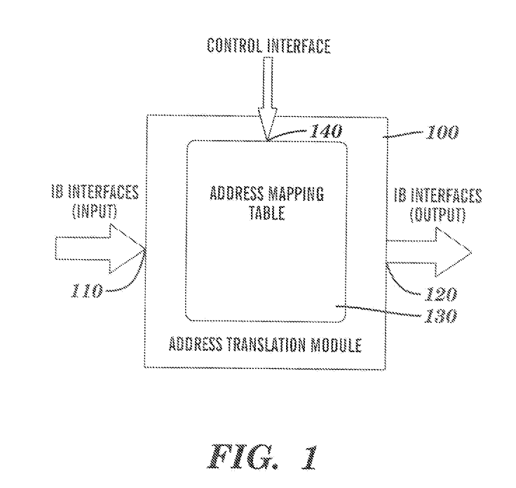

An address translation module 100 according to an exemplary embodiment is shown in FIG. 1. The module has one or more InfiniBand input interfaces 110 and output interfaces 120. In a real implementation, the input and output can share the same physical interface. Those skilled in the art will appreciate how these interfaces may be implemented. The module also includes a mapping table 130 that maps virtual HCA addresses to physical HCA addresses.

Assuming there is only one input interface and one input interface for simplicity of explanation, then for each InfiniBand packet received from the input interface, the module consults the mapping table using the destination address of the packet as the virtual HCA address. If there is a corresponding physical HCA address entry in the table 130, the module 100 replaces the destination (virtual) address with the physical HCA address found and forwards the packet with the physical HCA address to the output interface. In the case that the packet is protected by end-to-end cyclic redundancy checking (CRC) for error checking, the CRC value may also be updated. If there is no corresponding entry in the table for the virtual address of the intercepted packet, the packet may be forwarded “as is” to its destination.

In order to support multiple InfiniBand virtual addresses for VM migration, the translation module intercepts InfiniBand traffic. To manage the mapping table, it provides a control interface 140 for adding, removing or changing entries. The control interface 140 is invoked when a new VM (with InfiniBand access) is created, destroyed, or migrated from one physical node to another. The control interface may be implemented in any matter suitable, as those skilled in the art will appreciate. There may be many ways to access the control interface 140. For example, the InfiniBand Management Datagram (MAD) service may be used, as well as other out-of-band mechanisms.

According to exemplary embodiments, to communicate with a virtual HCA, an InfiniBand device (virtual or physical) can just use its virtual HCA address as the target address. Since the address translation is done by modifying InfiniBand packets in the network, the target physical HCA which hosts the virtual HCA does not need to support multiple addresses.

The address translation module 100 may be implemented in several manners. For example, it may be implemented as a standalone device connected to an InfiniBand subnet. In this implementation, a subnet manager sets up the switching/routing in such a way that all traffic target to virtual HCA addresses is switched/routed to the translation module stand alone device.

The translation module may be implemented using dedicated hardware, e.g., an ASIC. But, it can also be implemented as a software module in a PC with InfiniBand interfaces. In order to perform the address translation, the PC needs to access its InfiniBand interface at the packet level instead of the Verbs level. The mapping table can be implemented using standard memory (DRAM or SRAM) or content addressable memory (CAM).

The translation module 100 can also be embedded into InfiniBand switches or routers. In this case, the module can have multiple input/output interfaces. The InfiniBand switches may forward packets based on the destination address of the packets. This can be achieved by simply adding an extra column for the physical HCA address into the switching/routing table for each virtual HCA address. Changing the destination address of a packet takes very little time, so this should not result in performance degradation.

The translation module 100 may reside in other places in the InfiniBand network. It may even be part of a physical InfiniBand HCA. It should also be noted that the translation module may be partitioned or replicated and reside in different places in the network. When it is replicated, care should be taken to keep mapping information consistent among replicas.

Performance may be improved when the translation module is implemented as part of an InfiniBand switch/router. Performance may be not be as ideal when the translation module is implemented in a standalone device, because of potential limited processing capability or bandwidth and the extra hop added in the communication path. Processing capacity and bandwidth can be increased implementing the translation module using multiple such standalone devices. The mapping table can be partitioned or replicated the multiple standalone devices to improve performance. In the extreme case, the translation module may be part of each InfiniBand end node. It can be implemented either as part of the HCA hardware or even as a piece of software. In this implementation, InfiniBand packets will have correct physical address when they are injected into the network, avoiding any further translations.

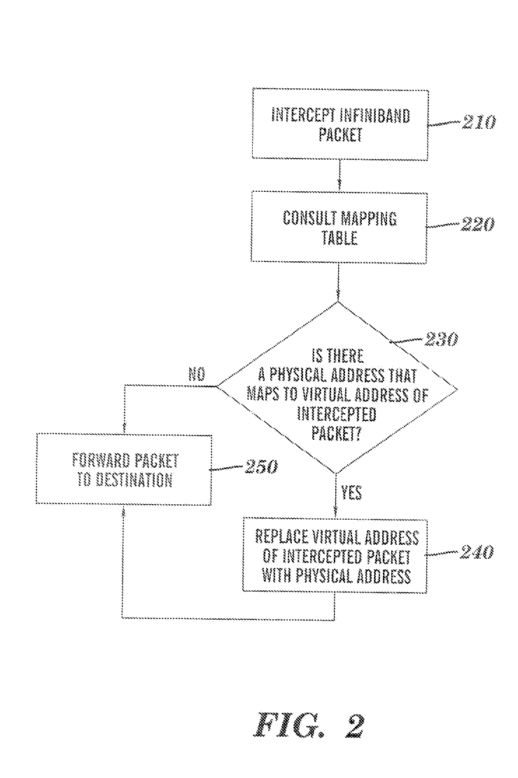

FIG. 2 is a flowchart showing exemplary steps of a method for performing address translation as described above. The method beings at step 210 at which an InfiniBand packet destined for a virtual InfiniBand HCA address, is intercepted. At step 220, an address mapping table mapping virtual HCA addresses to physical HCA addresses is consulted using the destination address of the packet as a virtual address. As explained above, the mappings of the virtual HCA addresses to the physical HCA addresses are updated when a VM with InfiniBand access is created, destroyed, or migrated from one physical node in the InfiniBand network to another. At step 230, a determination is made whether there is a physical HCA address in the table is mapped to the virtual HCA address of the intercepted packet. If so, the virtual address of the intercepted InfiniBand packet is replaced with the corresponding physical HCA address at step 240. Otherwise, the packet is forwarded without modification to its destination address at step 250.

The embodiments described above can be embodied in the form of computer-implemented processes and apparatuses for practicing those processes. Exemplary embodiments may be implemented in computer program code executed by one or more network elements. Embodiments include computer program code containing instruction embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical writing or cabling, through fiber optics, or via electromagnetic radiation, wherein, when the computer program code is loaded into and executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from he scope of the invention. In addition, many modifications may be made to adapt a particular situation of material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

We claim:

1. A translation module, comprising:
at least one input interface for intercepting InfiniBand packets in an InfiniBand network, destined for InfiniBand Host Channel Adapters (HCAs);
an address mapping table mapping virtual HCA addresses to physical HCA addresses;
a control interface for updating mappings of virtual HCA addresses to physical HCA addresses in the address mapping table when a virtual machine (VM) with InfiniBand access is created, destroyed, or migrated from one physical node to another in the InfiniBand network; and
an output interface, wherein for each InfiniBand packet intercepted by the input interface, the address mapping table is consulted using the destination address of the intercepted InfiniBand packet as a virtual HCA address, and if there is a physical HCA address in the table that is mapped to the virtual HCA address of the intercepted InfiniBand packet, the destination address of the intercepted InfiniBand packet is replaced with the corresponding physical HCA address and forwarded to the output interface.

2. The module of claim 1, wherein if there is no physical HCA address in the mapping table corresponding to the virtual HCA address of the intercepted InfiniBand packet, the packet is forwarded without modification to its destination address.

3. The translation module of claim 1, wherein the module is a stand-alone device connected to an InfiniBand subnet, wherein a subnet manager sets up switching and routing of packets in such a way that all traffic destined for a virtual HCA address is switched through the translation module.

4. The translation module of claim 1, wherein the module is embedded in an InfiniBand switch or router.

5. The translation module of claim 1, wherein the translation module is in a physical InfiniBand HCA.

6. The translation module of claim 1, wherein the module is partitioned into several devices in the InfiniBand network, and the mapping table is partitioned among the devices.

7. The translation module of claim 1, wherein the module is included in each InfiniBand end node.

8. A method for translating, comprising:
intercepting an InfiniBand packet in an InfiniBand network, destined for a virtual InfiniBand Host Channel Adapter (HCA) address;
consulting an address mapping table mapping virtual HCA addresses to physical HCA addressee using the designation address of the intercepted InfiniBand packet as a virtual address, wherein the mappings of the virtual HCA addresses to the physical HCA addresses are updated when a virtual machine (VM) with InfiniBand access is created, destroyed, or migrated from physical node to another in the InfiniBand network; and
if there is a physical HCA address in the table that is mapped to the virtual HCA address of the intercepted InfiniBand packet, replacing the virtual HCA address of the intercepted InfiniBand packet with the corresponding physical HCA address.

9. The method of claim 8, wherein if there is no physical HCA address in the mapping table corresponding to the virtual HCA address of the intercepted InfiniBand packet, the packet is forwarded without modification to its destination address.

10. The method of claim 8, wherein the steps are performed in a stand-alone device connected to an InfiniBand subnet, wherein a subnet manager sets up switching and routing of packets in such a way that all traffic destined for a virtual HCA address is switched through the standalone device.

11. The method of claim 8, wherein the steps are performed in an InfiniBand switch or router.

12. The method of claim 8, wherein the steps are performed in a physical InfiniBand HCA.

13. The method of claim 8, wherein the steps are performed in several devices in the InfiniBand network, and the mapping table is partitioned among the devices.

14. The method of claim 8, wherein the steps are performed in each InfiniBand end node.

15. A computer program product for performing translation, comprising a computer usable medium having a computer readable program, wherein the computer readable medium, when executed on a computer, caused the computer to:
intercept an InfiniBand packet in an InfiniBand network, destined for a virtual InfiniBand Host Channel Adapter (HCA) address:
consult an address mapping table mapping virtual HCA addresses to physical HCA addresses using the destination address of the packet as a virtual HCA address, wherein the mappings of the virtual HCA addresses to the physical HCA addresses are updated when a virtual machine (VM) with InfiniBand access is created, destroyed, or migrated from physical node to another in the InfiniBand network; and
if there is a physical HCA address in the table that is mapped to the virtual HCA address of the intercepted InfiniBand packet, replace the virtual HCA address of the intercepted InfiniBand packet with the corresponding physical HCA address.

16. The computer program product of claim 15, wherein if there is no physical, HCA address in the mapping table corresponding to the virtual HCA address of the intercepted InfiniBand packet, the packet is forwarded without modification to its destination address.

17. The computer program product of claim 15, wherein the product is included a stand-alone device connected to an InfiniBand subnet, wherein a subnet manager sets up switching and routing of packets in such a way that all traffic destined for a virtual HCA address is switched through the standalone device.

18. The computer program product of claim 15, wherein the product is included in an InfiniBand switch or router.

19. The computer program product of claim 15, wherein the product is included in a physical InfiniBand HCA.

20. The computer program product of claim 15, wherein the product is partitioned into several devices in the InfiniBand network, and the mapping table is partitioned among the devices.
